(19) United States
(12) Patent Application Publication
(10) Pub. No.: US 2005/0207109 A1
(43) Pub. Date: Sep. 22, 2005

(54) Array of serial ATA data storage devices serially linked to a computer by a single cable

(76) Inventor: Josef Rabinovitz, Chatsworth, CA (US)

Correspondence Address: W. Edward Johansen, 11661 San Vicemte Boulevard, Los Angeles, CA, 90049, US

(21) Appl. No.: 11/009,395

(22) Filed: Dec. 10, 2004

Related U.S. Application Data
(63) Continuation-in-part of application No. 10/317,037, filed on Dec. 9, 2002, now Pat. No. 6,856,508.

(51) Int. Cl. G06F 1/16

(52) U.S. Cl. 361/685

(57) ABSTRACT

A computer includes a first enclosure, a processor with a host bus, a host bus adapter and a first Serial ATA data signal connector. The processor is disposed in the first enclosure. The host bus adapter is coupled to the host bus. The first Serial ATA data signal connector is electrically coupled to the host bus adapter. A peripheral data storage system includes a second enclosure, a backplane and a power connector. The backplane has a plurality of slots and is coupled to the second enclosure. The power connector coupled to the backplane. The peripheral data storage system also includes a plurality of Serial ATA data storage devices each of which is inserted into one of the slots of the backplane and a second data signal connector that is mechanically coupled to the backplane and electrically coupled to the Serial ATA data storage devices. A cable couples the first data signal connector to the second data signal connector.

This application is a continuation-in-part of an application filed Dec. 9, 2002 under Ser. No. 10/317,037.

### BACKGROUND OF THE INVENTION

The invention relates to Serial Advanced Technology Attachment (ATA) communication between a computer and a plurality of Serial ATA data storage devices.

U.S. patent application No. 20030083325 teaches a combined computer and peripheral data storage system that includes a computer and a peripheral data storage enclosure. The computer has a central processor, a host PCI bus and a serial to PCI host bus adapter that is coupled to the host PCI bus. The peripheral data storage enclosure includes a plurality of Serial ATA data storage devices and a serial to parallel PCI interface that is coupled to each of the Serial ATA data storage devices, a parallel PCI to serial interface coupled to the serial to parallel PCI interface and a serial PCI link interconnect. The serial PCI link-interconnect couples the parallel PCI to serial interface of the peripheral data storage enclosure to the serial to PCI host bus adapter of the computer.

U.S. patent application No. 20030221061 teaches a system that interfaces device controllers to Serial ATA data storage devices by a serial connection. A controller is arranged in an active configuration. The functional block of the controller includes a host interface, a processor, a bus bridge, an interrupt manager, DMA circuitry, XOR circuitry and cache memory. The serial interface is connected to the controller through a PCI or PCIX bus. Each Serial ATA data storage device in the array is coupled by a serial connection to the serial interface.

U.S. patent application No. 20040010660 teaches a data storage module that includes five disk drives conforming to a serial ATA standard. A controller includes multiple serial busses. The controller also includes five copies of storage device interface logic. PCI interface logic is attached to a PCI bus.

U.S. patent application No. 20040162926 teaches a serial advanced technology attachment interface between a computer and a plurality of serial ATA data storage devices. The computer includes a central processor and an inexpensive high performance, high reliability intermediate hard disk drive adapter utilizing the Serial ATA method of communicating between the central processor and the hard disk drives.

The inventor hereby incorporates the above referenced patents into this specification.

### SUMMARY OF THE INVENTION

The present invention relates generally to a computer and a peripheral data storage subsystem. The computer includes first enclosure and a central processor having a host bus. The central processor is disposed in the first enclosure. The peripheral data storage subsystem includes a second enclosure, a backplane and a power connector. The backplane has a plurality of slots and is coupled to the second enclosure. The power connector coupled to the backplane. The backplane has a plurality of slots and is coupled to the second enclosure.

In the first aspect of the invention the computer also includes a host bus adapter having a plurality of Serial ATA ports and a first data signal connector. The host bus adapter is coupled to the host bus of the central processor. The first data signal connector is capable of carrying Serial ATA data signals. The first data signal connector is mechanically coupled to the first enclosure and electrically coupled to the host bus adapter.

In the second aspect of the invention the peripheral data storage system also includes a plurality of serial ATA data storage devices and a second data signal connector. Each serial ATA data storage data device is inserted into one of the slots of the backplane. The second data signal connector is capable of carrying the Serial ATA data signals of all of the Serial ATA data storage devices. The second data signal connector is mechanically coupled to the backplane and electrically coupled to the serial ATA data storage devices.

In the third aspect of the invention a cable is capable of carrying the Serial ATA data signals of all of the Serial ATA data storage devices. The cable couples the first data signal connector to the second data signal connector so that an array of serial ATA data storage devices are serially linked to a computer by a single cable.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a schematic drawing of a combined computer and peripheral data storage system that includes a computer having a processor, a host PCI bus, a SATA host adapter with a plurality of Serial ATA ports and a first Serial ATA data signal connector, a peripheral data storage subsystem having a second Serial ATA data signal connector and a cable according to the present invention.

FIG. 2 is top plan view of a PCI card having a SATA host adapter and the first Serial ATA data signal connector of FIG. 1.

FIG. 3 is a front perspective of the six-bay peripheral data storage subsystem of FIG. 1 according to the first embodiment.

FIG. 4 is a rear perspective of the six-bay peripheral data storage subsystem of FIG. 1.

FIG. 5 is a schematic drawing of the peripheral data storage system of FIG. 1 that includes six of SATA data storage devices, the second Serial ATA data signal connector, a backplane and a power connector.

FIG. 6 is a schematic drawing of the front of an eight-bay, rack mount peripheral data storage subsystem according to the second embodiment.

FIG. 7 is a rear perspective of the eight-bay, rack mount peripheral data storage subsystem of FIG. 6.

FIG. 8 is a schematic drawing of the eight-bay, rack mount peripheral data storage system of FIG. 6 that includes eight SATA data storage devices, a second Serial ATA data signal connector, a communication connector, a backplane and a power connector.

FIG. 9 is a front perspective of an eight-bay peripheral data storage subsystem according to the third embodiment.

FIG. 10 is a rear perspective of the eight-bay peripheral data storage subsystem of FIG. 9.

### DESCRIPTION OF THE PREFERRED EMBODIMENT

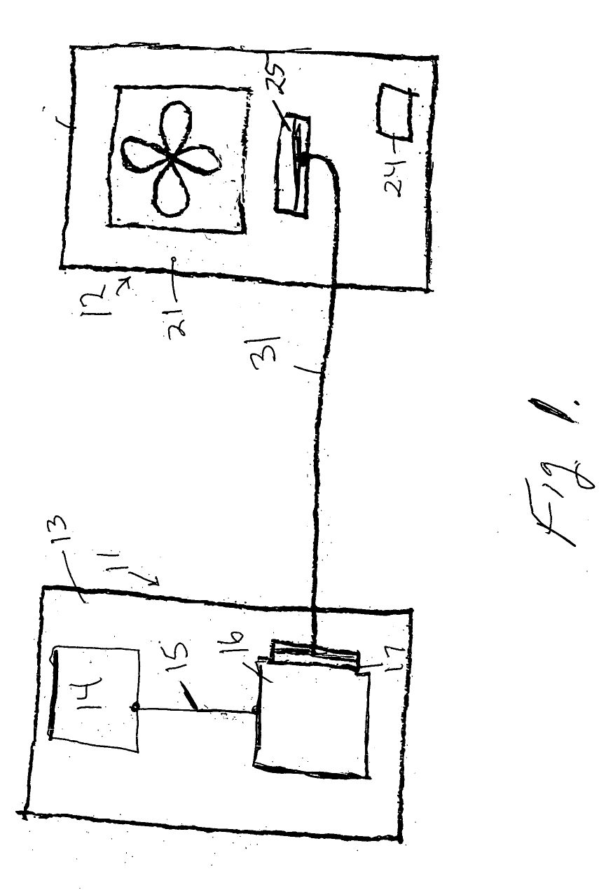

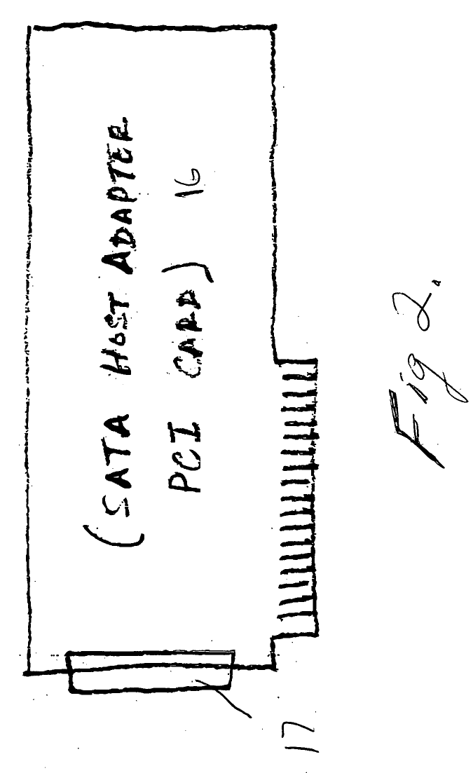

Referring to FIG. 1 in conjunction with FIG. 2 a combined computer and peripheral data storage system 10 include computer 11 and a peripheral data storage subsystem 12. The computer includes a first enclosure 13, a processor 14 having a host PCI bus 15, a SATA host adapter 16 with a plurality of Serial ATA ports and a first Serial ATA data signal connector 17. The processor 14 is disposed in the first enclosure 13. The SATA host adapter 16 is coupled to the host PCI bus 15. The first Serial ATA data signal connector 17 is mechanically coupled to the first enclosure 13 and electrically coupled to the host bus adapter 16.

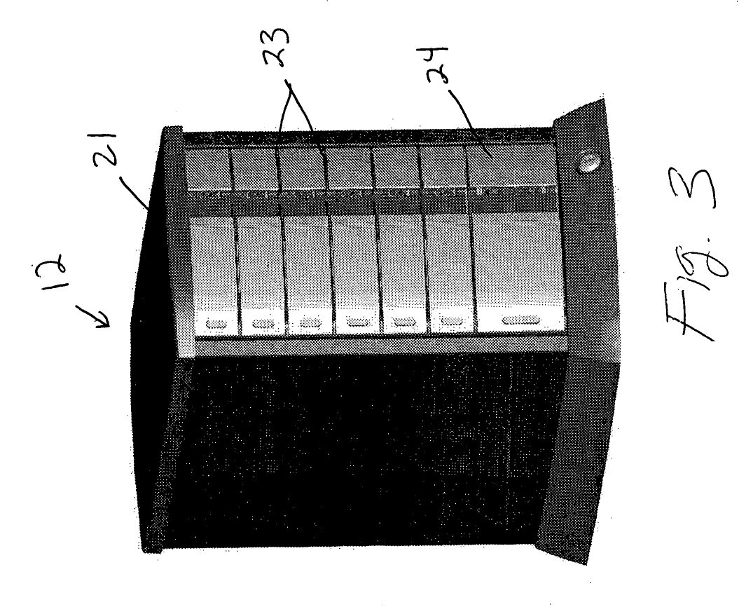

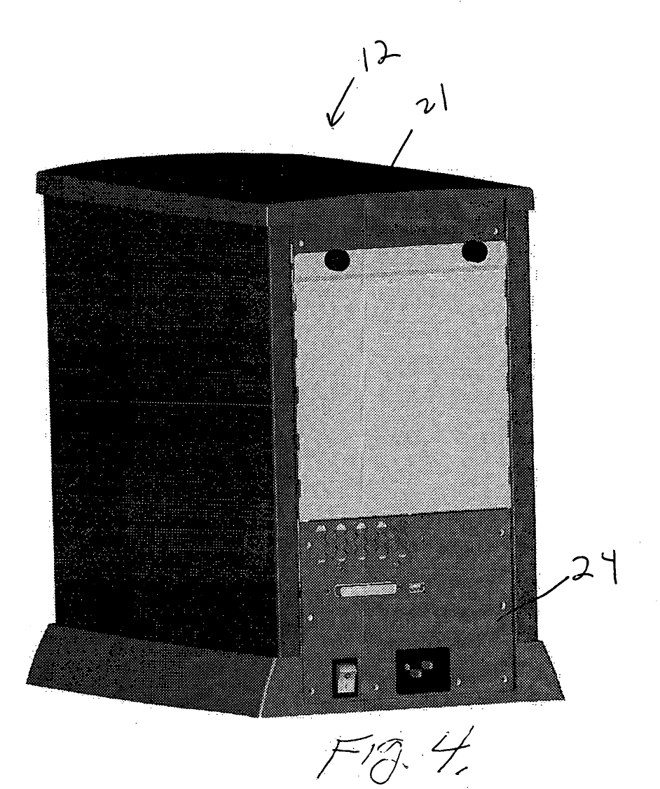

Referring to FIG. 3 in conjunction with FIG. 1 and FIG. 4 the peripheral data storage subsystem 12 also include a second enclosure 21, a backplane 22 that has a plurality of slots 23, a power connector 24, a second Serial ATA data signal connector 25 and a plurality of Serial ATA data storage devices 26. The power connector 24 is coupled to the backplane 22. Each Serial ATA data storage device 26 is inserted into one of the slots 23 of the backplane 22. The second Serial ATA data signal connector 25 is mechanically coupled to the backplane 22 and electrically coupled to the Serial ATA data storage devices 26.

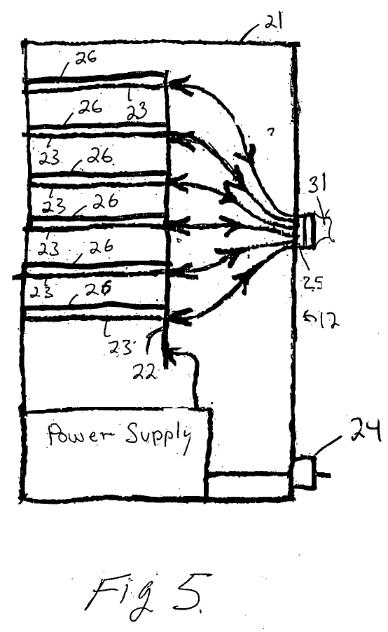

Referring to FIG. 5 in conjunction with FIG. 1 a cable 31 couples the first Serial ATA signal connector 15 to the second Serial ATA signal connector 25. The cable 31 is capable of carrying not only the Serial ATA data signals for a plurality of Serial ATA data storage devices 26, but also additional signals that are used for remote disk array health status monitoring including either activity or failure of any of the Serial ATA data storage devices 26.

Still referring to FIG. 5 in conjunction with FIG. 1 when the host bus adapter 16 is a six-port Serial ATA storage adapter it is able to control six Serial ATA data storage drives 26. One of six individual Serial ATA cables can be connected to each of six Serial ATA data storage devices 26. The six-port Serial ATA storage adapter may have RAID functionality that is implemented with either hardware or software. In another embodiment a Serial ATA storage device adapter may have a plurality of Serial ATA ports in order to handle a like number of Serial ATA data storage devices 26.

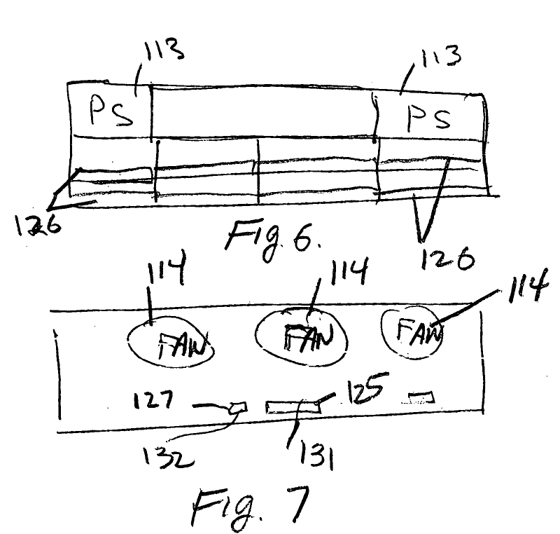

Referring to FIG. 6 in conjunction with FIG. 7 a peripheral data storage subsystem 112 may have eight bays, two power supplies 113, three fans 114, a second Serial ATA signal connector 125, eight Serial ATA storage devices 126, a communication connector 127. The second Serial ATA signal connector 125 is capable of carrying the Serial ATA data signals for the eight Serial ATA data storage devices 126. The communication connector 127 is capable of carrying additional signals that are used for remote disk array health status monitoring including either activity or failure of any of the eight Serial ATA data storage devices 126.

Referring to FIG. 7 a cable 131 couples the first Serial ATA signal connector 15 to the second Serial ATA signal connector 125. The cable 131 is capable of carrying the Serial ATA data signals for the eight Serial ATA data storage devices 126. A cable 132 couples computer 11 to the communication connector 127. The cable 132 is capable of carrying signals that are used for remote disk array health status monitoring including either activity or failure of any of the eight Serial ATA data storage devices 126.

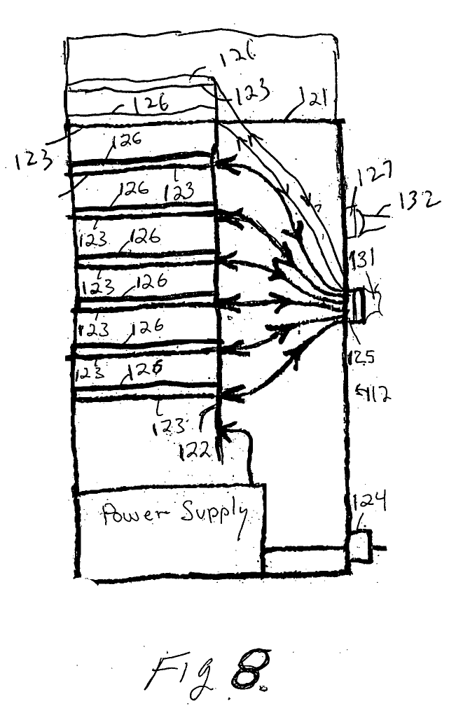

Referring to FIG. 8 in conjunction with FIG. 1 and FIG. 7 when the host bus adapter 16 is a eightsix-port Serial ATA storage adapter it is able to control the eight Serial ATA data storage drives 126. One of eight individual Serial ATA cables can be connected to each of eight Serial ATA data storage devices 126. The eight-port Serial ATA storage adapter may have RAID functionality that is implemented with either hardware or software. In another embodiment a Serial ATA storage device adapter may have a plurality of Serial ATA ports in order to handle a like number of Serial ATA data storage devices.

From the foregoing it can be seen that an array of Serial ATA data storage devices serially linked to a computer by a single cable. In the description, specific materials and configurations have been set forth in order to provide a more complete understanding of the present invention.

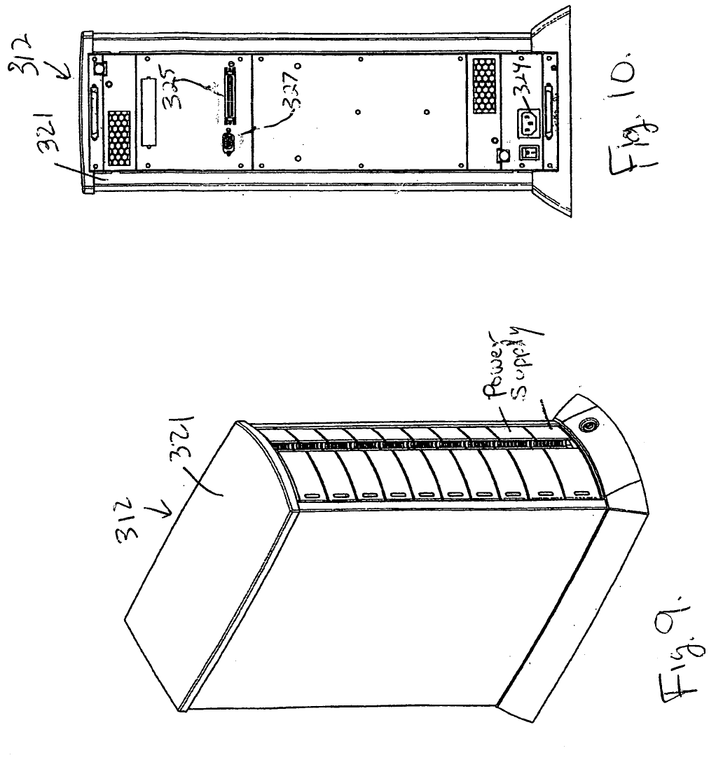

Referring to FIG. 9 in conjunction with FIG. 1 and FIG. 10 the eight-bay peripheral data storage subsystem 312 also include a second enclosure 321, a backplane that has eight slots, a power connector 324, a second Serial ATA data signal connector 325, eight Serial ATA data storage devices and a communication connector 327. The power connector 324 is coupled to the backplane. Each Serial ATA data storage device is inserted into one of the slots of the backplane. The second Serial ATA data signal connector 325 is mechanically coupled to the backplane and electrically coupled to the Serial ATA data storage devices.

Accordingly it is intended that the foregoing disclosure be considered only as an illustration of the principle of the present invention.

1. A combined computer and peripheral data storage system comprising:
a. a first enclosure
b. a processor having a host bus and being disposed in said first enclosure;
c. a host bus adapter coupled to said host bus having a plurality of Serial ATA ports;
d. a second enclosure;
e. a backplane having a plurality of slots and being coupled to said second enclosure;
f. a power connector coupled to said backplane;
g. a plurality of Serial ATA data storage devices each of which is inserted into one of said slots of said backplane and each of which generates Serial ATA data signals;
h. a first Serial ATA data signal connector mechanically coupled to said first enclosure and electrically coupled to said Serial ATA ports of said host bus adapter wherein said first Serial ATA signal connector is capable of carrying said Serial ATA data signals of all of said Serial ATA data storage devices;
i. a second Serial ATA data signal connector mechanically coupled to said backplane and electrically coupled to said Serial ATA data storage devices wherein said second Serial ATA signal connector is capable of carrying said Serial ATA data signals of all of said Serial ATA data storage devices; and
j. a cable coupling said first Serial ATA data signal connector to said second Serial ATA data signal connector wherein said cable is capable of carrying said Serial ATA data signals of all of said Serial ATA data storage devices.

2. A peripheral data storage system for use with a computer that includes a first enclosure, a processor having a host bus and being disposed in the first enclosure and a host bus adapter that is coupled to the host bus having a plurality of Serial ATA ports, said peripheral data storage system comprising:
a. a second enclosure;
b. a backplane having a plurality of slots and being coupled to said second enclosure
c. a power connector coupled to said backplane;
d. a plurality of Serial ATA data storage devices each of which is inserted into one of said slots of said backplane and each of which generates Serial ATA data signals;
e. a first Serial ATA data signal connector mechanically coupled to the first enclosure and electrically coupled to said Serial ATA ports of said host bus adapter wherein said first Serial ATA signal connector is capable of carrying said Serial ATA data signals of all of said Serial ATA data storage devices;
f. a second Serial ATA data signal connector mechanically coupled to said backplane and electrically coupled to said Serial ATA data storage devices wherein said second Serial ATA signal connector is capable of carrying said Serial ATA data signals of all of said Serial ATA data storage devices; and
g. a cable coupling said first Serial ATA data signal connector to said second Serial ATA data signal connector wherein said cable is capable of carrying said Serial ATA data signals of all of said Serial ATA data storage devices.
